(19) United States
(12) Patent Application Publication
(10) Pub. No.: US 2008/0314910 A1
(43) Pub. Date: Dec. 25, 2008

(54) MULTI-WALL THERMALLY-ISOLATED DISPOSABLE PAPER HOT BEVERAGE CUP

(75) Inventors: Terrill Beal, Upland, CA (US); Jeanette Goglia, Burbank, CA (US); Kenneth Canty, Pasadena, CA (US); Paul Glum, Mission Viejo, CA (US); Robert Loreen, Danville, CA (US); Thomas E. Popoli, Greenwood, SC (US)

Correspondence Address: DORITY & MANNING, P.A., POST OFFICE BOX 1449, GREENVILLE, SC, 29602-1449, US

(73) Assignee: Group International, Inc., Pomona, CA (US)

(21) Appl. No.: 12/142,077

(22) Filed: Jun. 19, 2008

Related U.S. Application Data
(60) Provisional application No. 60/936,347, filed on Jun. 20, 2007.

(51) Int. Cl. A47J 41/00

(52) U.S. Cl. 220/592.16

(57) ABSTRACT

Multi-wall thermally-isolated disposable cups are especially adapted for use as hot beverage cups. A two layer, laminated construction results in a corrugated layer which is fully secured 100% around the circumference of the cup. Enclosed corrugations of a relatively larger size form elongated air pockets running substantially top to bottom of the cup, and provide thermal isolation between the interior contents of the cup and the grasp of a user's hand about the outside of the cup. An outer finished layer or sleeve extends from the rim to the base of the cup. The methodologies and resulting products have improved cup integrity and are relatively cooler to the user's grasp, even with improved heat preservation for the cup's contents, such as hot coffee or other hot beverages.

### PRIORITY CLAIM

This application claims priority under 35 U.S.C. 119(e) of U.S. Provisional Patent Application Ser. No. 60/936,347, filed Jun. 20, 2007, entitled “MULTI-WALL THERMALLY-ISOLATED DISPOSABLE PAPER HOT BEVERAGE CUP,” which is hereby incorporated by reference in its entirety for all purposes.

### FIELD OF THE INVENTION

The presently disclosed technology relates to disposable paper cups and corresponding methodologies. More particularly, the present technology relates to construction and providing of multi-wall thermally-isolated disposable cups especially adapted for use as hot beverage cups.

### BACKGROUND OF THE INVENTION

Heretofore, disposable cups have typically involved polystyrene, expanded polystyrene, and/or paper. While acceptable aesthetically, polystyrene cups have been generally used for hot and cold drinks, but have had limited acceptance in the gourmet hot beverage application. However, external condensation can be an issue when used with cold drinks, rendering the cups slippery to the user's grasp. Expanded polystyrene cups are much better insulators as compared with polystyrene based cups. However, both polystyrene and expanded polystyrene cups are not biodegradable, and are therefore regarded as environmentally unfriendly.

Paper based cups, generally speaking, are considered to be more environmentally friendly in the sense that they are perceived to be biodegradable. However, single-wall paper cups can be unstable over time when used with larger quantities of fluids and/or fluids which are hot and potentially able to break down part of the paper cup integrity. Such loss of integrity can involve either loss of shape or loss of seal (i.e., resulting leakage). Such single-wall paper cups are also limited by poor insulation characteristics, which can make them uncomfortable to use with either cold or hot drinks, due to heat transfer.

Various multi-layered paper cups have been provided in efforts to advance the art. For example, U.S. Pat. No. 6,257,485 to Sadlier (and assigned on its face to Insulair, Inc.) is entitled “Insulated cup and method of manufacture.” In one disclosed embodiment, an insulating cup or container and a corresponding method of manufacture relates to providing a sidewall blank having two sections separated by a fold score, and a separate insulating sheet adhesively fastened to one of the sections. The blank is folded in half along the fold score, to form a three-layered assembly with an insulating sheet in the middle. To reduce the thickness of the seam, the blank is thinned in the area adjacent a fold score prior to folding. The assembly is wrapped around a mandrel to bring the outer edges together at a side seam to form a sidewall. The side seam is sealed, the bottom is added, and the rim is formed.

Other examples of U.S. patents entitled “Insulated cup and method of manufacture” include U.S. Pat. Nos. 6,378,766; 6,196,454; and 6,085,970. U.S. Pat. No. 6,422,456 is entitled “Three-layered insulated cup and method of manufacture.” U.S. Pat. No. 7,014,044 is entitled “Cup and lid holder and dispenser” while U.S. Design Pat. No. D417,845 is entitled “Lid for drinking cup.” Various Published U.S. patent applications include Publication Nos. 20060144915 and 20050236468, both of which are entitled “Insulating cup wrapper and insulated container formed with wrapper” while Publication No. 20060071008 is entitled “Lid with bistably valved drinking spout.”

The disclosures of the foregoing patents and published applications are fully incorporated herein for all purposes.

A particular development in the area of using disposable paper cups for hot beverage cups has been the ever increasing popularity of specialty hot beverage drinks. Examples of such specialty hot beverage drinks were café lattes, cappuccinos, espresso and other specialty hot beverage and flavoring mixtures that consumers would otherwise dictate. Such drinks are frequently served in venues that would result, if not require, the consumer to drink the hot beverage at another location. Such “traveling” or removed consumption could literally either be on the go while traveling and/or at a remote place or later time at the consumer's convenience.

Specialty hot beverage drinks have been served in larger portions than what was originally the popularly demanded 8 ounce size cup. Early expansion of service size to the consumer initially encompassed 12 ounce and 16 ounce sizes, but serving sizes of such products have now expanded to even 20 and 24 ounce sizes.

The relatively larger hot beverage servings have brought with it particular problems. For example, it is a technical challenge to keep such relatively larger volumes of hot beverages hot, within the disposable paper cup, and with the consumer all the while being able to touch the cup without adverse sensory perceptions. Stated another way, all of the foregoing accomplishments also preferably would be without the interior liquid volume of hot beverage from thermally conducting from the inner cup wall to the outside wall of the cup.

Heretofore, attempts to address such circumstances involved literally double cups. In other words, for each single serving, the service or product provider would use two disposable paper cups, one inside the other, to serve one serving of hot beverage with the outside wall of the outer cup being comfortable for the user to grasp. Such approach is expensive, and wasteful, and ineffective in the instance of “doubled” cups untimely separating.

While various implementations of multi-wall paper cups have been developed, no design or method of manufacture has emerged that generally encompasses all of the desired characteristics as hereafter presented in accordance with the subject technology.

### SUMMARY OF THE INVENTION

The present subject matter recognizes and addresses several of the foregoing issues, and others concerning certain aspects of multi-wall paper cups. Thus, broadly speaking, an object of certain embodiments of the presently disclosed technology is to provide improved designs for certain disposable paper cups and corresponding methodologies. More particularly, it is a present object to provide design and construction of improved multi-wall thermally-isolated disposable cups especially adapted for use as hot beverage cups.

Another present object is to provide a disposable paper hot beverage cup which has improved integrity while also being cooler to user's touch though keeping hot beverage contents thereof hot.

Yet another present object is to provide an improved disposable hot beverage cup having lamination involving two layers but which is secured completely around its laminated circumference, for improved integrity and performance.

Another present object is to provide improved multi-wall thermally isolated disposable paper hot beverage cups which have improved captured air pockets for improved thermal characteristics.

Still further, a present object is to provide improved multi-wall thermally isolated disposable paper hot beverage cups which have improved extended outer sleeve features for improved stability and integrity characteristics.

Aspects of certain exemplary embodiments of the present subject matter can additionally relate to the selection of particular weights of paper (as rated in GSM-grams per square meter), the size and placement/orientation of the ripples or corrugations captured between or in adjacent layers, and the extent of the lamination between various layers around the circumference of the entire improved cup.

Still further aspects of yet still other embodiments of the present subject matter provide enhancements to manufacturing methodologies for paper based disposable cups and associated type devices. In such context, the present subject matter in part advantageously can make use of steps and procedures as adjunct to paper handling aspects of printing processes and production.

Still further, it is to be understood that the present technology equally applies to the resulting devices and structures disclosed and/or discussed herewith, as well as the corresponding involved methodologies.

One exemplary embodiment of the present subject matter relates to a multi-layer thermally-isolated beverage container, comprising a side wall having an inside layer, an outside layer, and a corrugated layer, captured between such inside and outside layers around the full circumference of such container, and attached to such inside layer around all edges, walls, and sides of such inside layer; and a bottom closure. Such exemplary embodiment in some variations thereof may further include adhesive disposed between such inside layer and such corrugated layer; and such outside layer and such corrugated layer may be preferably attached so as to form a plurality of parallel channels of air along such container, for thermally insulating contents of such container from such outside layer thereof.

In such various foregoing embodiments, such inside layer and such outside layer may preferably comprise paper. Still further, such paper may comprise paper having a relatively high GSM weight, where GSM stands for grams per square meter.

In still further present variations of the foregoing, such bottom closure may be recessed. In still further variations of such present exemplary embodiment, such outside layer may be fully laminated to such corrugated layer so as to form a plurality of parallel channels of air along such container, for thermally insulating contents of such container from such outside layer thereof; such inside layer may be fully glued to such corrugated layer around all edges, walls, and sides of such inside layer; such inside layer and such outside layer may comprise paper; and such container may further include a top curl opposite such bottom closure thereof.

In another present exemplary embodiment, a multi-walled, thermally-isolating disposable cup for use with hot beverages, may preferably comprise an inner cup core having an outer circumference, a length, an open top, and a bottom portion; a backing attached to the entirety of such outer circumference and along the entire length of such inner cup core, on substantially all edges, walls and sides thereof; and a bottom closure attached to such bottom portion.

In such foregoing exemplary embodiment of a multi-walled, thermally-isolating disposable cup, such backing may further comprise a corrugated layer and an outer cup layer laminated thereto. Still further, such backing may be configured relative to such inner cup core such that such corrugated layer is situated between such inner cup core and such outer cup layer.

In various alternative embodiments of the foregoing present exemplary multi-walled, thermally-isolating disposable cup, a plurality of parallel air channels may be formed by such corrugated layer between such outer cup layer and such inner cup core.

In other present variations, such inner cup core and such outer cup layer may comprise paper.

Still further, those of ordinary skill in the art will appreciate from the full disclosure herewith that the present subject matter may equally relate to apparatus or to corresponding methodology for making same, or further relate to devices for use in making such present apparatus. One present exemplary embodiment of such methodology may relate to a method for producing a multi-layer thermally-isolated beverage container. Such exemplary method may comprise the steps of providing a sheet having first and second sections, respectively separated by first and second offset lines, and having a fold line between such first and second offset lines, such sheet having respective interior and exterior surfaces, and a bottom edge; attaching a corrugated layer to the entire interior surface of such first section of such sheet up to such first offset line; applying adhesive on the entire interior surface of such second section of such sheet up to such second offset line; folding at such fold line such sheet second section onto such corrugated layer, so as to form a fold edge and a leading edge of such sheet; attaching such leading edge to such fold edge; and attaching a bottom closure to such bottom edge of such sheet.

In various alternatives of the foregoing exemplary methodology, such step of attaching such corrugated layer and/or such step of attaching such leading edge to such fold edge, may use lamination.

Another present exemplary embodiment relates to a sidewall blank for a thermally-isolated beverage container. Such present exemplary sidewall blank may preferably comprise an inside layer having respective interior and exterior surfaces; an outside layer having respective interior and exterior surfaces; and a corrugated layer, situated between such respective inside and outside layers, with adhesive provided between such corrugated layer and the entirety of such exterior surface of such inside layer. In such sidewall blank preferred arrangement, such corrugated layer may form a plurality of parallel captured air pockets between such respective inside and outside layers.

Additional objects and advantages of the present subject matter are set forth in, or will be apparent to those of ordinary skill in the art from, the detailed description herein. Also, it should be further appreciated by those of ordinary skill in the art that modifications and variations to the specifically illustrated, referenced, and discussed features and/or steps hereof may be practiced in various embodiments and uses of the disclosed technology without departing from the spirit and scope thereof, by virtue of present reference thereto. Such variations may include, but are not limited to, substitution of equivalent means, steps, features, or materials for those shown, referenced, or discussed, and the functional, operational, or positional reversal of various parts, features, steps, or the like.

Still further, it is to be understood that different embodiments, as well as different presently preferred embodiments, of this technology may include various combinations or configurations of presently disclosed steps, features or elements, or their equivalents (including combinations of features, configurations, or steps thereof not expressly shown in the figures or stated in the detailed description).

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1A is an isometric view, seen from a substantially side and partial top perspective, of a partially constructed cup in accordance with a present exemplary embodiment;

FIG. 1B is a cross-section elevational view of a completed cup of a present exemplary embodiment, taken generally along the sectional line 1B-1B, as indicated in present FIG. 1A;

FIG. 2A is an external side surface or plan view of outside flats for inclusion in an exemplary embodiment of the present subject matter;

FIG. 2B is a external side surface or plan view similar to that of present FIG. 2A, in which present exemplary insulating material is illustrated;

FIG. 2C is a generally side or edge view of the present subject matter of FIG. 2B, representing side to side and top to bottom connection of the indicated layers;

FIG. 2D is a generally plan view of the bottom blank of the subject matter of present FIGS. 2B and 2C in a completed or assembled state;

FIG. 2E is a cross-sectional view of the subject matter of present FIG. 2D, taken generally along the sectional line 2E-2E indicated therein;

FIG. 3A is an external side surface or plan view of inside flats for inclusion in an exemplary embodiment of the present subject matter;

FIG. 3B is a view similar to that of present FIG. 3A, in which the present subject matter of FIG. 3A is folded;

FIG. 3C is a generally side or edge view of the present subject matter of FIG. 3B, representing side to side and top to bottom connection of the indicated layers;

FIG. 4A is a sectional view of a present exemplary cup embodiment in accordance with the present subject matter, after wrapping of the blank but before sealing thereof;

FIG. 4B is a sectional view of a present exemplary cup embodiment in accordance with the present subject matter, after wrapping of the blank and after sealing thereof;

FIG. 5A is an external side view of a finished outside layer of an exemplary cup in accordance with the present subject matter;

FIG. 5B is a side view of the finished backside of the exemplary outside cup layer as illustrated in present FIG. 5A, prior to lamination of the full length ripple wall backing thereof in accordance with the present subject matter;

FIG. 5C is a generally top view (looking down), illustrating an exemplary view of a lamination layer adhered to the back of an outside finished layer, from top to bottom and side to side, in accordance with present subject matter;

FIG. 6A is a generally side view of exemplary ripple wall construction that is laminated to the backside of the finished outside layer; and

FIG. 6B is a generally top view (looking down), illustrating an exemplary view of the relatively larger volume lamination layer glued to the back of an the outside finished layer, from top to bottom and side to side, in accordance with present subject matter.

Repeat use of reference characters throughout the present specification and appended drawings is intended to represent same or analogous features, elements, or steps of the present subject matter.

### DETAILED DESCRIPTION OF THE PREFERRED EMBODIMENTS

As discussed in the Summary of the Invention section, the present subject matter is particularly concerned with certain aspects of multi-wall paper cups. More particularly, the present subject matter is concerned with providing improved designs for certain disposable paper cups and corresponding methodologies. Still further, it is a present concern to provide design and construction of improved multi-wall thermally-isolated disposable cups especially adapted for use as hot beverage cups.

Selected combinations of aspects of the disclosed technology correspond to a plurality of different embodiments of the present subject matter. It should be noted that each of the exemplary embodiments presented and discussed herein should not insinuate limitations of the present subject matter. Features or steps illustrated or described as part of one embodiment may be used in combination with aspects of another embodiment to yield yet further embodiments. In additional, certain features may be interchanged with similar devices or features not expressly mentioned which perform the same or similar function.

In general, it is to be understood that presently disclosed methodologies may advantageously be practiced in the context, of paper/printing manufacturers, who would as an auxiliary manufacturing operation, manufacture disposable paper cups. More particularly, such manufacturers would produce a multi-wall disposable paper cup, to specific construction criteria.

While aspects of the present subject matter may involve a multi-wall paper cup designed with a relatively very high GSM paper weight (as valued in grams/square meter), a presently preferred exemplary embodiment is based on attaching a backing, fully laminated, to an outside layer that would be constructed of a corrugated design. Such corrugated outside layer would be intended for holding air. Preferably, per such embodiment, once such top layer and associated backing were laminated together, they would then be glued 100% on all edges, walls and sides to an inner cup core.

While the above process and resulting product is useful for present purposes, the process of fully laminating the corrugated air retaining backing to the outer wall, and then 100% gluing all to the inner core cup, provides an opportunity for further reducing manufacturing costs. Such is particularly true for those embodiments where, in a blanking process, the wrapper is cut out of the insulated multi-ply top sheet and wrapped around and adhered to the inner cup, through a laminating process. Though relatively significant amounts of value-added multi-ply sheet is trimmed during the blanking process of adhering the wrapper to the core cup, and a relatively significant amount of adhesive is used to secure the insulated laminated top sheet across the entire surface of the base core cup, the end result meets both present design and quality criteria, particularly in the context of use with premium, specialty hot beverages.

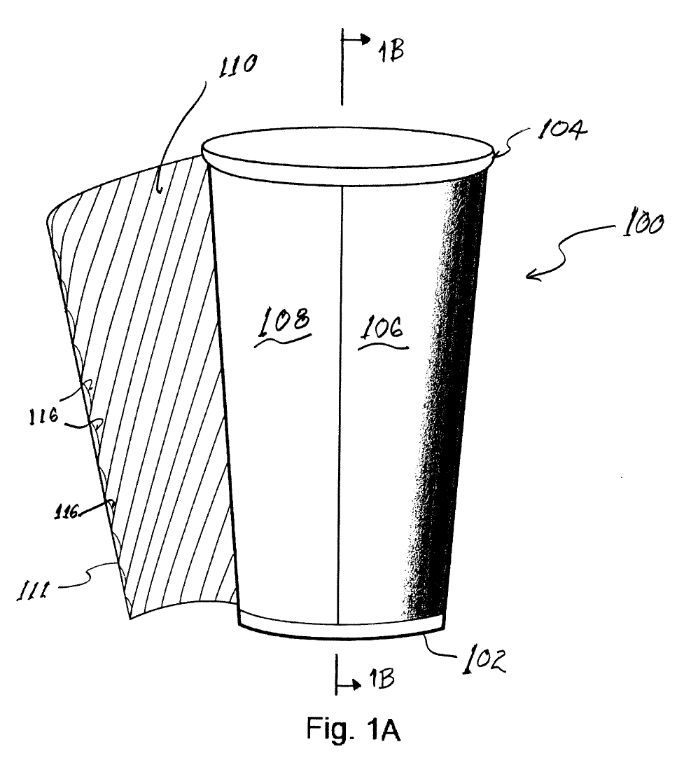

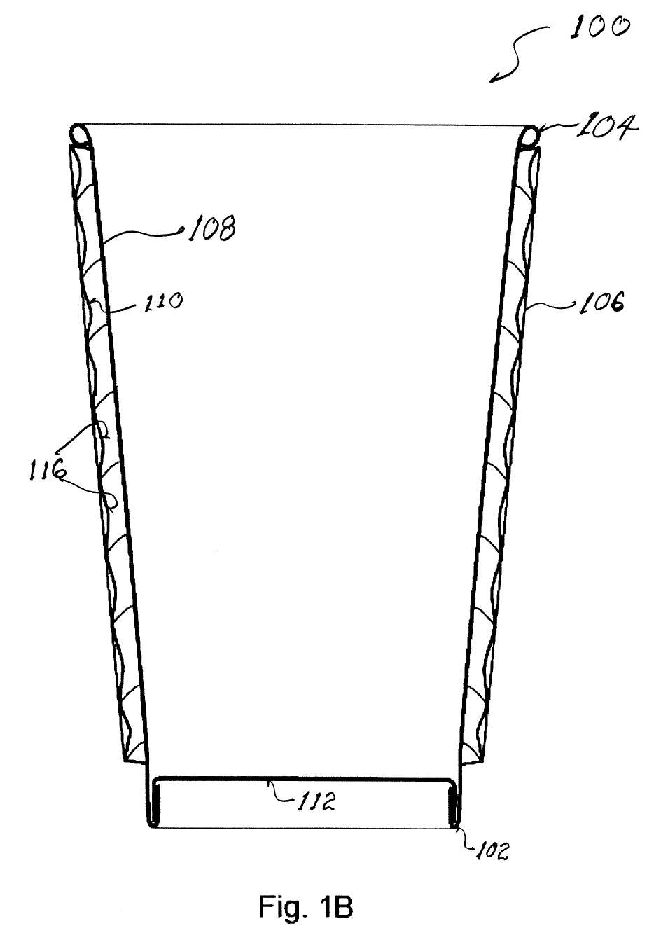

Reference will now be made in detail to exemplary presently preferred embodiments involving an exemplary multi-wall insulated disposable paper hot beverage cup generally 100. Referring now to the drawings, FIG. 1A illustrates an isometric view, seen from a substantially side and partial top perspective, of a partially constructed cup generally 100 in accordance with the present technology. FIG. 1B is a cross-section elevational view of a completed cup generally 100 of such present exemplary embodiment, taken generally along the sectional line 1B-1B, as indicated in present FIG. 1A.

Referring to both such figures collectively, cup 100 in its finished condition (and in some of its partially completed conditions) has a bottom edge 102 and a top curl 104. Side panel or layer 106 is an external side surface of the present construction generally 100, while panel or layer 108 is an internal side surface of such present construction. The partially completed construction of FIG. 1A reveals the internal corrugated layer or portion generally 110. As will be understood by those of ordinary skill in the art, the end or edge 111 of corrugated materials 110 will interface relative to the end or edge 107 of outer layer 106, so that the full circumference of cup 100 is completely enclosed with corrugation 110.

FIG. 1B further illustrates that bottom 112 of cup 100 is to an extent recessed relative to (that is, situated “above”) lower edge 102 of the cup design.

Again, referring collectively to FIGS. 1A and 1B, the subject exemplary design represents a laminated arrangement, with two layers, and with the corrugated element secured 100% around the circumference of cup 100. The illustrations also represent other facets of some exemplary embodiments of the present subject matter. For example, such FIGS. 1A and 1B reflect that the outer layer (or sleeve) 106 extends from the rim (that is, top curl 104) to the base (that is, bottom 112) of exemplary disposable paper cup 100. Also shown is that the ripples (generally 116) of corrugation 110 run substantially between such rim and base of cup 100, so as to in essence form plural parallel channels of air, which as closed by the present subject matter, form isolation (or insulative) air channels, for an insulated multi-wall disposable paper hot beverage cup generally 100. Advantageously, such air pockets formed by such channels are relatively larger than with other designs, giving rise to both improved integrity of the subject cup and improved thermal performance thereof.

Still further, such FIGS. 1A and 1B presently represent that in accordance with present subject matter, the ripples 116 and their associated corrugation layer or sheet 110 are laminated to the outer wall 106, around it's entire effective circumference.

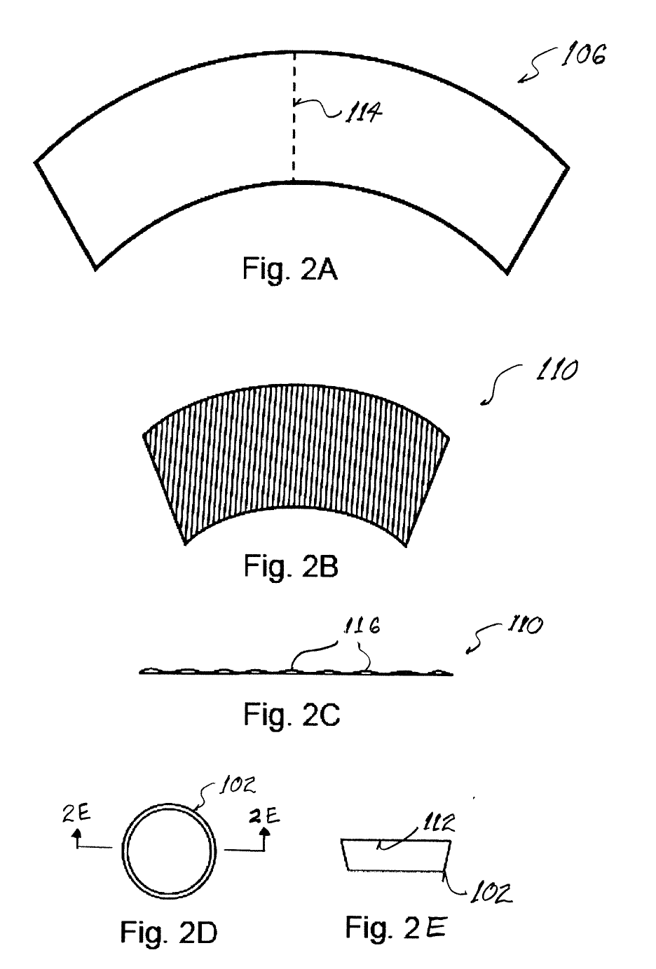

FIG. 2A is an external side surface or plan view of outside flats generally 106 for inclusion in an exemplary embodiment of the present subject matter, with an illustrated representative center line 114 thereof.

FIG. 2B is an external side surface or plan view similar to that of present FIG. 2A, in which present exemplary insulating material generally 110 is illustrated. FIG. 2C is a generally side or edge view of the present subject matter of FIG. 2B, representing side to side and top to bottom connection of the indicated layers 110 of cup 100, with corrugation 116.

FIG. 2D is a generally plan view of the bottom blank of the subject matter of present FIGS. 2B and 2C in a completed or assembled state, while FIG. 2E is a cross-sectional view of the subject matter of present FIG. 2D, taken generally along the sectional line 2E-2E indicated therein, reflecting both lower edge 102 and bottom 112 of cup 100.

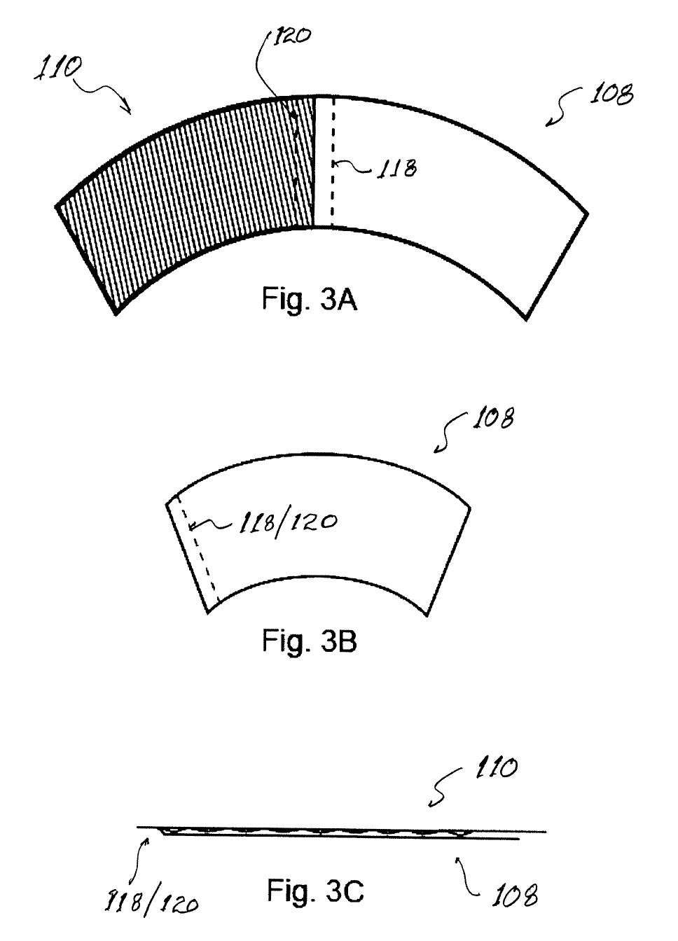

FIG. 3A is an external side surface or plan view of inside flats generally 108 for inclusion in an exemplary embodiment of the present subject matter. The left side in the illustration of FIG. 3A reflects securement of corrugation 110 to inside flat 108. Otherwise, areas 108 and 110, respectively, have offset lines 118 and 120, which are involved with determining the final relationships of various facets of the present subject matter, once fully assembled.

More specifically, FIG. 3B is a view similar to that of present FIG. 3A, in which the present subject matter of FIG. 3A is folded. Consequently, one can observe generally speaking that the indicated offset lines 118 and 120 have aligned. The purpose and functionality of such alignment of offset lines 118 and 120 are further demonstrated by present FIG. 3C, which illustrates a generally side or edge view of the present subject matter of FIG. 3B, representing side to side and top to bottom connection of the indicated layers. More particularly, such FIG. 3C represents the resulting relationships as indicated among the features 108 and 110, and the offset lines or edges 118 and 120.

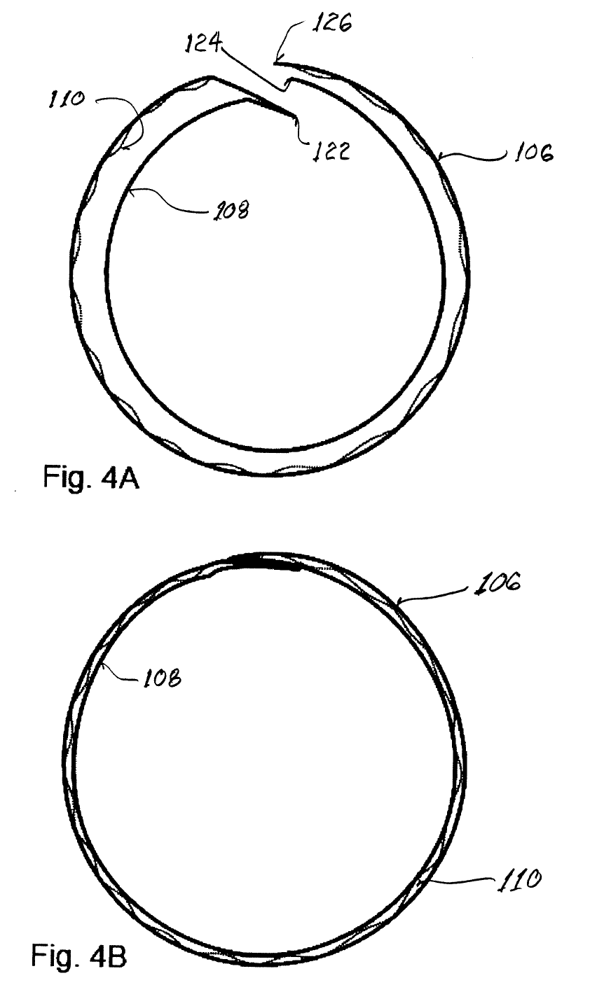

FIG. 4A is a sectional view of a present exemplary cup embodiment in accordance with the present subject matter, after wrapping of the blank but before sealing thereof. FIG. 4B is a sectional view of a present exemplary cup embodiment in accordance with the present subject matter, after wrapping of the blank and after sealing thereof. Before completion of the sealing of such subject matter, inside layer 108 has a leading edge 122 on one end thereof, and opposite to that another edge or end 124. The leading edge 122 is joined in common with outer layer 106, such that corrugation layer 110 is captured between inside layer 108 and outside layer 106. Outside layer 106 also has another edge, a free edge or end 126, which is sealed in a radially inward direction, along with free edge 124, resulting in the illustrated exemplary subject matter of FIG. 4B, in which such formerly free edges 124 and 126 are overlapped with their radially inward counterparts.

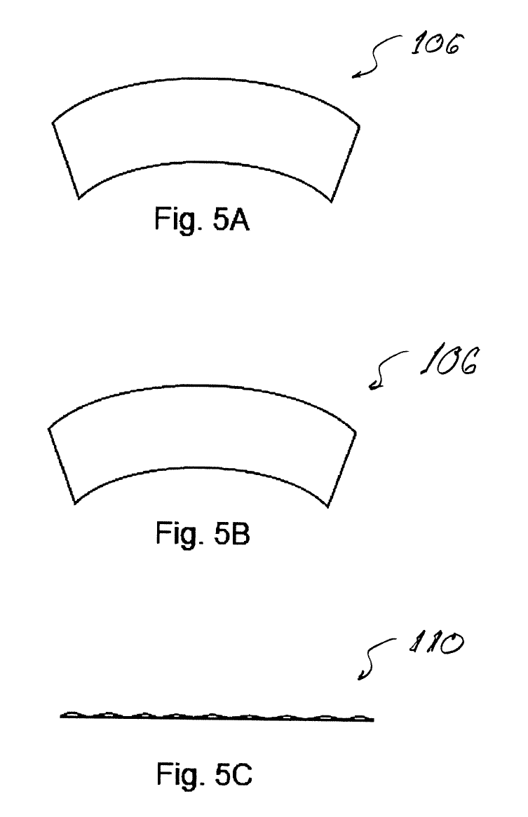

FIG. 5A is an external side view of a finished outside layer generally 106 of an exemplary cup in accordance with the present subject matter. FIG. 5B is a side view of the finished backside of the exemplary outside cup layer generally 106 as illustrated in present FIG. 5A, prior to lamination of the full length ripple wall backing thereof in accordance with the present subject matter.

FIG. 5C is a generally top view (looking down), illustrating an exemplary view of a lamination layer adhered to the back of an outside finished layer, from top to bottom and side to side, in accordance with present subject matter. Such illustration clearly demonstrates and represents a beneficial aspect of some of the present exemplary embodiments, which is that the laminated ripple wall with trap air, acting as a heat buffer from the inside cup, and transferring heat to the outside wall.

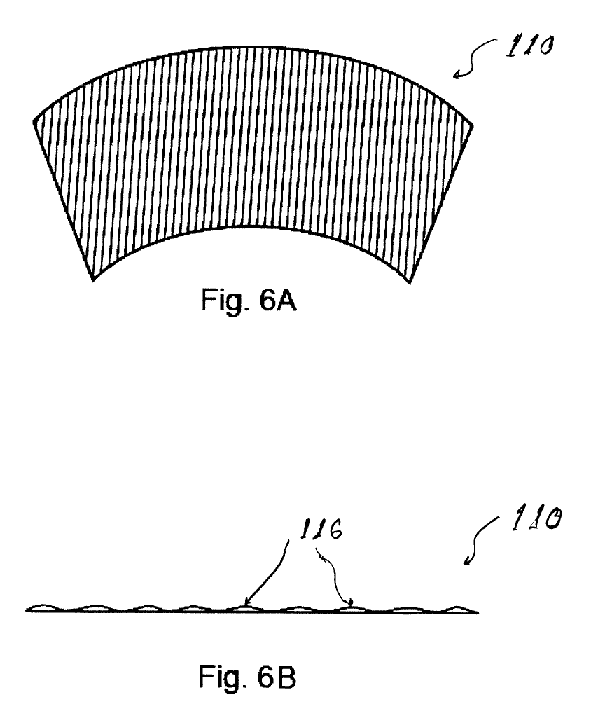

FIG. 6A is a generally side view of exemplary ripple wall construction generally 110 that is laminated to the backside of the finished outside layer. FIG. 6B is a generally top view (looking down), illustrating an exemplary view of the relatively larger volume lamination layer glued (or otherwise adhered) to the back of an the outside finished layer, from top to bottom and side to side, in accordance with present subject matter. Again, such illustration clearly demonstrates that the laminated ripple wall (generally corrugation layer or wall 110 with separate ripples or corrugations 116) will trap air, acting as a heat buffer from the inside cup, and transferring heat to the outside wall.

Tests were prepared against a market sample, using two different constructions in accordance with the present subject matter, have respective different weights of paper. It is to be understood that different variations may be practiced in accordance with the present subject matter, which means that no embodiment of the present subject matter is limited to use of a particular weight of paper, or any other particular variable. In determining these results, a Mannix brand Infrared Thermometer was situated exactly 12 inches away from each cup and shot at the center of each cup in the same place each time, for sensing temperatures. The reported temperatures in the below chart are in Fahrenheit.

Comparative testing based on two present samples with different
weights of paper

| | GSM | | | | |
|---|---|---|---|---|---|
| | (grams/sq. | | After 5 | After 10 | After 15 |
| Item | meter) | Start Temp | minutes | minutes | minutes |
| Market | 22.6 | 170 | 143 | 137 | 135 |
| sample | | | | | |
| China #1 | 23.4 | 170 | 151 | 145 | 139 |
| China #2 | 23.9 | 170 | 137 | 135 | 132 |

While the present subject matter has been described in detail with respect to specific embodiments thereof, it will be appreciated that those skilled in the art, upon attaining an understanding of the foregoing may readily adapt the present technology for alterations or additions to, variations of, and/or equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

What is claimed is:

1. A multi-layer thermally-isolated beverage container, comprising:
a side wall having an inside layer, an outside layer, and a corrugated layer, captured between said inside and outside layers around the full circumference of said container, and attached to said inside layer around all edges, walls, and sides of said inside layer; and
a bottom closure.

2. A multi-layer thermally-isolated beverage container as in claim 1, further including:
adhesive disposed between said inside layer and said corrugated layer; and
wherein said outside layer and said corrugated layer are attached so as to form a plurality of parallel channels of air along said container, for thermally insulating contents of said container from said outside layer thereof.

3. A multi-layer thermally-isolated beverage container as in claim 1, wherein said inside layer and said outside layer comprise paper.

4. A multi-layer thermally-isolated beverage container as in claim 3, wherein said inside layer and said outside layer comprise paper having a relatively high GSM weight, where GSM stands for grams per square meter.

5. A multi-layer thermally-isolated beverage container as in claim 1, wherein said bottom closure is recessed.

6. A multi-layer thermally-isolated beverage container as in claim 1, wherein:
said outside layer is fully laminated to said corrugated layer so as to form a plurality of parallel channels of air along said container, for thermally insulating contents of said container from said outside layer thereof;
said inside layer is fully glued to said corrugated layer around all edges, walls, and sides of said inside layer;
said inside layer and said outside layer comprise paper; and
said container further includes a top curl opposite said bottom closure thereof.

7. A multi-walled, thermally-isolating disposable cup for use with hot beverages, comprising:
an inner cup core having an outer circumference, a length, an open top, and a bottom portion;
a backing attached to the entirety of said outer circumference and along the entire length of said inner cup core, on substantially all edges, walls and sides thereof; and
a bottom closure attached to said bottom portion.

8. A multi-walled, thermally-isolating disposable cup as in claim 7, wherein:
said backing comprises a corrugated layer and an outer cup layer laminated thereto; and
said backing is configured relative to said inner cup core such that said corrugated layer is situated between said inner cup core and said outer cup layer.

9. A multi-walled, thermally-isolating disposable cup as in claim 8, further including a plurality of parallel air channels formed by said corrugated layer between said outer cup layer and said inner cup core.

10. A multi-walled, thermally-isolating disposable cup as in claim 7, wherein said inner cup core and said outer cup layer comprise paper.

11. A multi-walled, thermally-isolating disposable cup as in claim 10, wherein:
said paper comprises paper having a relatively high GSM weight, where GSM stands for grams per square meter; and
said bottom closure is recessed.

12. A method for producing a multi-layer thermally-isolated beverage container, comprising the steps of:
providing a sheet having first and second sections, respectively separated by first and second offset lines, and having a fold line between said first and second offset lines, said sheet having respective interior and exterior surfaces, and a bottom edge;
attaching a corrugated layer to the entire interior surface of said first section of said sheet up to said first offset line;
applying adhesive on the entire interior surface of said second section of said sheet up to said second offset line;
folding at said fold line said sheet second section onto said corrugated layer, so as to form a fold edge and a leading edge of said sheet;
attaching said leading edge to said fold edge; and
attaching a bottom closure to said bottom edge of said sheet.

13. A method as in claim 12, wherein said step of attaching said corrugated layer uses lamination.

14. A method as in claim 12, wherein said step of attaching said leading edge to said fold edge uses lamination.

15. A method as in claim 12, wherein said bottom closure is recessed.

16. A method as in claim 12, wherein said sheet comprises paper.

17. A sidewall blank for a thermally-isolated beverage container, comprising:
an inside layer having respective interior and exterior surfaces;
an outside layer having respective interior and exterior surfaces; and
a corrugated layer, situated between said respective inside and outside layers, with adhesive provided between said corrugated layer and the entirety of said exterior surface of said inside layer.

18. A sidewall blank as in claim 17, wherein said corrugated layer forms a plurality of parallel captured air pockets between said respective inside and outside layers.

19. A sidewall blank as in claim 17, wherein said respective inside and outside layers each comprise paper.
